(19) United States
(12) Patent Application Publication
(10) Pub. No.: US 2020/0134280 A1
(43) Pub. Date: Apr. 30, 2020

(54) Fingerprint Sensor

(71) Applicant: INVENSENSE, INC., San Jose, CA (US)

(72) Inventors: Nikhil Apte, Palo Alto, CA (US); Leonardo Baldasarre, San Jose, CA (US); Mei-Lin Chan, Milpitas, CA (US); Ventsislav Yanchev, San Jose, CA (US)

(21) Appl. No.: 16/661,718

(22) Filed: Oct. 23, 2019

Related U.S. Application Data
(60) Provisional application No. 62/749,715, filed on Oct. 24, 2018.
(60) Provisional application No. 62/760,863, filed on Nov. 13, 2018.

(51) Int. Cl. G06K 9/00; B06B 1/06

(52) U.S. Cl. CPC G06K 9/0002; B06B 1/0692

(57) ABSTRACT

A fingerprint sensor is provided herein. A method for operating the fingerprint sensor can comprise selecting a pair of electrode elements from a first set of electrode elements and a second set of electrode elements of a second electrode. The first electrode is located on a first side of a piezoelectric layer; the second electrode is located on a second side of the piezoelectric layer. The first side and the second side are opposite sides of the piezoelectric layer. The method also can comprise transmitting ultrasonic signals using the pair of electrode elements based on a position of a switch element being in a first position, and receiving ultrasonic signals using the pair of electrode elements based on the position of the switch element being in a second position.

### CROSS-REFERENCE TO RELATED APPLICATIONS

This application claims the benefit of U.S. Provisional Application Ser. No. 62/749,715, filed Oct. 24, 2018, and entitled “FINGERPRINT SENSOR,” the entirety of which is expressly incorporated herein by reference. This application also claims the benefit of U.S. Provisional Application Ser. No. 62/760,863, filed Nov. 13, 2018, and entitled “OPERATING A TWO-DIMENSIONAL ARRAY OF ULTRASONIC TRANSDUCERS,” the entirety of which is expressly incorporated herein by reference.

### BACKGROUND

Fingerprint sensing solutions are deployed in consumer products, such as smartphones and other types of user equipment devices, and there has been an increased demand for better performance and reliability from consumers. Fingerprint sensor technologies generally rely on a sensor and a processing element. Unique challenges exist to provide fingerprint sensing solutions and associated levels of service for the increasing demand of performance and reliability of such consumer products.

### BRIEF DESCRIPTION OF THE DRAWINGS

Various non-limiting embodiments are further described with reference to the accompanying drawings in which:

FIG. 1 is a diagram illustrating a piezoelectric micromachined ultrasonic transducer device having a center pinned membrane, according to some embodiments.

FIG. 2 is a diagram illustrating an example of membrane movement during activation of a piezoelectric micromachined ultrasonic transducer device, according to some embodiments.

FIG. 3 is a top view of the piezoelectric micromachined ultrasonic transducer device of FIG. 1, according to some embodiments.

FIG. 4 is a simulated map illustrating maximum vertical displacement of the membrane of the piezoelectric micromachined ultrasonic transducer device shown in FIGS. 1-3, according to some embodiments.

FIG. 5 illustrates an example, non-limiting, fingerprint sensor that comprises a single electrode access in accordance with one or more embodiments described herein.

FIG. 6 illustrates another example, non-limiting, fingerprint sensor that comprises a single electrode access in accordance with one or more embodiments described herein.

FIG. 7 illustrates an example, non-limiting, fingerprint sensor that comprises a dual electrode access in accordance with one or more embodiments described herein.

FIG. 8 illustrates another example, non-limiting, fingerprint sensor that comprises a dual electrode access in accordance with one or more embodiments described herein.

FIG. 9 illustrates an example, non-limiting, fingerprint sensor with dual electrode access and electromagnetic interference shield in accordance with one or more embodiments described herein.

FIG. 10 illustrates another example, non-limiting, fingerprint sensor with dual electrode access and electromagnetic interference shield in accordance with one or more embodiments described herein.

FIG. 11 illustrates an example, non-limiting, fingerprint sensor that comprises a piezoelectric micromachined ultrasonic transducer plus bulk/film based piezoelectric film that is a combination of the one or more embodiments described herein.

FIG. 12A illustrates an example, non-limiting, schematic representation of signals for a sensor that comprises a single drive.

FIG. 12B illustrates an example, non-limiting, schematic representation of signals for a sensor that comprises a differential drive in accordance with one or more embodiments described herein.

FIG. 13 illustrates a representation of a sensor that is formed on piezo in accordance with one or more embodiments described herein.

FIG. 14A illustrates an example, non-limiting, fingerprint sensor that comprises multiple electrodes with a single piezoelectric layer in accordance with one or more embodiments described herein.

FIG. 14B illustrates an example, non-limiting, fingerprint sensor that comprises a multiple layer of piezo with multiple electrodes in accordance with one or more embodiments described herein.

FIG. 15A illustrates a sensor that facilitates frontside sensing in accordance with one or more embodiments described herein.

FIG. 15B illustrates a sensor that facilitates backside sensing in accordance with one or more embodiments described herein.

FIG. 16 illustrates a device that comprises an architecture using piezoelectric bulk material or a piezoelectric film to generate and/or detect ultrasonic waves in accordance with one or more embodiments described herein.

FIG. 17 illustrates a device that comprises an architecture using piezoelectric bulk material or a piezoelectric film to generate and/or detect the ultrasonic waves in accordance with one or more embodiments described herein.

FIG. 18 illustrates a flow diagram of an example, non-limiting, method for operating a sensor device in accordance with one or more embodiments described herein.

FIG. 19 illustrates a flow diagram of an example, non-limiting, method for operating a sensor device for backside sensing in accordance with one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments.

### Notation and Nomenclature

Some portions of the detailed description which follow are presented in terms of procedures, logic blocks, processing and other symbolic representations of operations on data within an electrical device. These descriptions and representations are the means used by those skilled in the data processing arts to most effectively convey the substance of their work to others skilled in the art. In this disclosure, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “transmitting,” “receiving,” “sensing,” “generating,” “imaging,” or the like, refer to the actions and processes of an electronic device such as an electrical device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example fingerprint sensing system and/or mobile electronic device described herein may include components other than those shown, including well-known components.

Various techniques described herein may be implemented in hardware, software, firmware, or any combination thereof, unless specifically described as being implemented in a specific manner Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

A conventional piezoelectric ultrasonic transducer able to generate and detect pressure waves can include a membrane with the piezoelectric material, a supporting layer, and electrodes combined with a cavity beneath the electrodes. Miniaturized versions are referred to as PMUTs (Piezoelectric Micromachined Ultrasonic Transducers). Typical PMUTs use an edge anchored membrane or diaphragm that maximally oscillates at or near the center of the membrane at a resonant frequency (f) proportional to h/a², where h is the thickness, and a is the radius of the membrane. Higher frequency membrane oscillations can be created by increasing the membrane thickness, decreasing the membrane radius, or both. Increasing the membrane thickness has its limits, as the increased thickness limits the displacement of the membrane. Reducing the PMUT membrane radius also has limits, because a larger percentage of PMUT membrane area is used for edge anchoring.

The described devices and array of devices can be used for generation of acoustic signals or measurement of acoustically sensed data in various applications, such as, but not limited to, medical applications, security systems, biometric systems (e.g., fingerprint sensors and/or motion/gesture recognition sensors), mobile communication systems, industrial automation systems, consumer electronic devices, robotics, etc. In one embodiment, the device can facilitate ultrasonic signal generation and sensing (transducer). Moreover, embodiments describe herein provide a sensing component including a silicon wafer having a two-dimensional (or one-dimensional) array of ultrasonic transducers.

### Piezoelectric Micromachined Ultrasonic Transducer (PMUT)

Systems and methods disclosed herein, in one or more aspects provide efficient structures for an acoustic transducer (e.g., a piezoelectric actuated transducer or PMUT). One or more embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the embodiments in additional detail.

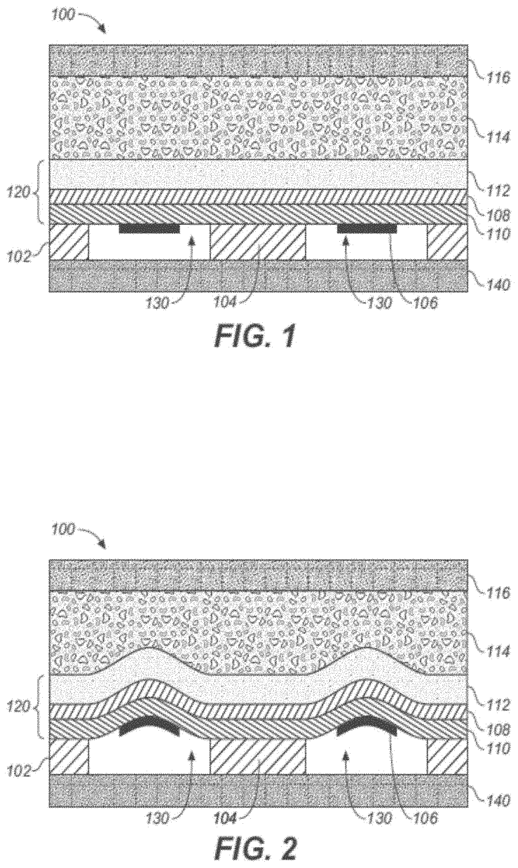

FIG. 1 is a diagram illustrating a PMUT device 100 having a center pinned membrane, according to some embodiments. PMUT device 100 includes an interior pinned membrane 120 positioned over a substrate 140 to define a cavity 130. In one embodiment, membrane 120 is attached both to a surrounding edge support 102 and interior support 104. In one embodiment, edge support 102 is connected to an electric potential. Edge support 102 and interior support 104 may be made of electrically conducting materials, such as and without limitation, aluminum, molybdenum, or titanium. Edge support 102 and interior support 104 may also be made of dielectric materials, such as silicon dioxide, silicon nitride or aluminum oxide that have electrical connections the sides or in vias through edge support 102 or interior support 104, electrically coupling a lower electrode 106 to electrical wiring in substrate 140. However, it is noted that, in some embodiments, interior support 104 is omitted.

In one embodiment, both edge support 102 and interior support 104 are attached to a substrate 140. In various embodiments, substrate 140 may include at least one of, and without limitation, silicon or silicon nitride. It should be appreciated that substrate 140 may include electrical wirings and connection, such as aluminum or copper. In one embodiment, substrate 140 includes a CMOS logic wafer bonded to edge support 102 and interior support 104. In one embodiment, the membrane 120 comprises multiple layers. In an example embodiment, the membrane 120 includes lower electrode 106, piezoelectric layer 110, and upper electrode 108, where lower electrode 106 and upper electrode 108 are coupled to opposing sides of piezoelectric layer 110. As shown, lower electrode 106 is coupled to a lower surface of piezoelectric layer 110 and upper electrode 108 is coupled to an upper surface of piezoelectric layer 110. It should be appreciated that, in various embodiments, PMUT device 100 is a microelectromechanical (MEMS) device.

In one embodiment, membrane 120 also includes a mechanical support layer 112 (e.g., stiffening layer) to mechanically stiffen the layers. In various embodiments, mechanical support layer 112 may include at least one of, and without limitation, silicon, silicon oxide, silicon nitride, aluminum, molybdenum, titanium, etc. In one embodiment, PMUT device 100 also includes an acoustic coupling layer 114 above membrane 120 for supporting transmission of acoustic signals. It should be appreciated that acoustic coupling layer can include air, liquid, gel-like materials, or other materials for supporting transmission of acoustic signals. In one embodiment, PMUT device 100 also includes platen layer 116 above acoustic coupling layer 114 for containing acoustic coupling layer 114 and providing a contact surface for a finger or other sensed object with PMUT device 100. It should be appreciated that, in various embodiments, acoustic coupling layer 114 provides a contact surface, such that platen layer 116 is optional. Moreover, it should be appreciated that acoustic coupling layer 114 and/or platen layer 116 may be included with or used in conjunction with multiple PMUT devices. For example, an array of PMUT devices may be coupled with a single acoustic coupling layer 114 and/or platen layer 116.

FIG. 2 is a diagram illustrating an example of membrane movement during activation of PMUT device 100, according to some embodiments. As illustrated with respect to FIG. 2, in operation, responsive to an object proximate platen layer 116, the lower electrode 106, and the upper electrode 108 deliver a high frequency electric charge to the piezoelectric layer 110, causing those portions of the membrane 120 not pinned to the surrounding edge support 102 or interior support 104 to be displaced upward into the acoustic coupling layer 114. This generates a pressure wave that can be used for signal probing of the object. Return echoes can be detected as pressure waves causing movement of the membrane, with compression of the piezoelectric material in the membrane causing an electrical signal proportional to amplitude of the pressure wave.

The described PMUT device 100 can be used with almost any electrical device that converts a pressure wave into mechanical vibrations and/or electrical signals. In one aspect, the PMUT device 100 can comprise an acoustic sensing element (e.g., a piezoelectric element) that generates and senses ultrasonic sound waves. An object in a path of the generated sound waves can create a disturbance (e.g., changes in frequency or phase, reflection signal, echoes, etc.) that can then be sensed. The interference can be analyzed to determine physical parameters such as (but not limited to) distance, density and/or speed of the object. As an example, the PMUT device 100 can be utilized in various applications, such as, but not limited to, fingerprint or physiologic sensors suitable for wireless devices, industrial systems, automotive systems, robotics, telecommunications, security, medical devices, etc. For example, the PMUT device 100 can be part of a sensor array comprising a plurality of ultrasonic transducers deposited on a wafer, along with various logic, control and communication electronics. A sensor array may comprise homogenous or identical PMUT devices 100, or a number of different or heterogonous device structures.

In various embodiments, the PMUT device 100 employs a piezoelectric layer 110, comprised of materials such as, but not limited to, Aluminum nitride (AlN), Scandium doped Aluminum Nitride (ScAlN), lead zirconate titanate (PZT), quartz, polyvinylidene fluoride (PVDF), and/or zinc oxide, to facilitate both acoustic signal production and sensing. The piezoelectric layer 110 can generate electric charges under mechanical stress and conversely experience a mechanical strain in the presence of an electric field. For example, the piezoelectric layer 110 can sense mechanical vibrations caused by an ultrasonic signal and produce an electrical charge at the frequency (e.g., ultrasonic frequency) of the vibrations. Additionally, the piezoelectric layer 110 can generate an ultrasonic wave by vibrating in an oscillatory fashion that might be at the same frequency (e.g., ultrasonic frequency) as an input current generated by an alternating current (AC) voltage applied across the piezoelectric layer 110. It should be appreciated that the piezoelectric layer 110 can include almost any material (or combination of materials) that exhibits piezoelectric properties, such that the structure of the material does not have a center of symmetry and a tensile or compressive stress applied to the material alters the separation between positive and negative charge sites in a cell causing a polarization at the surface of the material. The polarization is directly proportional to the applied stress and is direction dependent so that compressive and tensile stresses results in electric fields of opposite polarizations.

Further, the PMUT device 100 comprises the lower electrode 106 and the upper electrode 108 that supply and/or collect the electrical charge to/from the piezoelectric layer 110. It should be appreciated that the lower electrode 106 and the upper electrode 108 can be continuous and/or patterned electrodes (e.g., in a continuous layer and/or a patterned layer). For example, as illustrated, the lower electrode 106 is a patterned electrode and the upper electrode 108 is a continuous electrode. As an example, the lower electrode 106 and the upper electrode 108 can be comprised of almost any metal layers, such as, but not limited to, Aluminum (Al)/Titanium (Ti), Molybdenum (Mo), etc., which are coupled with an on opposing sides of the piezoelectric layer 110. In one embodiment, PMUT device also includes a third electrode.

According to an embodiment, the acoustic impedance of acoustic coupling layer 114 is selected to be similar to the acoustic impedance of the platen layer 116, such that the acoustic wave is efficiently propagated to/from the membrane 120 through acoustic coupling layer 114 and platen layer 116. As an example, the platen layer 116 can comprise various materials having an acoustic impedance in the range between 0.8 to 4 MRayl, such as, but not limited to, plastic, resin, rubber, Teflon, epoxy, etc. In another example, the platen layer 116 can comprise various materials having a high acoustic impedance (e.g., an acoustic impendence greater than 10 MRayl), such as, but not limited to, glass, aluminum-based alloys, stainless steel, sapphire, etc. In some implementations, the sensor can be mounted below a display, such as, for example, an organic LED display. In some implementations, the platen layer 116 can be formed by the display and can comprise the layers that make up the display. Typically, the platen layer 116 can be selected based on an application of the sensor. For instance, in fingerprinting applications, platen layer 116 can have an acoustic impedance that matches (e.g., exactly or approximately) the acoustic impedance of human skin (e.g., 1.6×10⁶ Rayl). Further, in one aspect, the platen layer 116 can further include a thin layer of anti-scratch material. In various embodiments, the anti-scratch layer of the platen layer 116 is less than the wavelength of the acoustic wave that is to be generated and/or sensed to provide minimum interference during propagation of the acoustic wave. As an example, the anti-scratch layer can comprise various hard and scratch-resistant materials (e.g., having a Mohs hardness of over 7 on the Mohs scale), such as, but not limited to sapphire, glass, MN, Titanium nitride (TiN), Silicon carbide (SiC), diamond, etc. As an example, PMUT device 100 can operate at 20 MHz and accordingly, the wavelength of the acoustic wave propagating through the acoustic coupling layer 114 and platen layer 116 can be 70-150 microns. In this example scenario, insertion loss can be reduced, and acoustic wave propagation efficiency can be improved by utilizing an anti-scratch layer having a thickness of 1 micron and the platen layer 116 as a whole having a thickness of 1-2 millimeters. Operating of the PMUT 100 could vary between several MHz to close to 100 MHz or higher. It is noted that the term “anti-scratch material” as used herein relates to a material that is resistant to scratches and/or scratch-proof and provides substantial protection against scratch marks.

In accordance with various embodiments, the PMUT device 100 can include metal layers (e.g., Aluminum (Al)/Titanium (Ti), Molybdenum (Mo), etc.) patterned to form the lower electrode 106 in particular shapes (e.g., ring, circle, square, octagon, hexagon, etc.) that are defined in-plane with the membrane 120. Electrodes can be placed at a maximum strain area of the membrane 120 or placed at close to either or both the surrounding edge support 102 and interior support 104. Furthermore, in one example, the upper electrode 108 can be formed as a continuous layer providing a ground plane in contact with mechanical support layer 112, which can be formed from silicon or other suitable mechanical stiffening material. In still other embodiments, the lower electrode 106 can be routed along the interior support 104, advantageously reducing parasitic capacitance as compared to routing along the edge support 102.

For example, when actuation voltage is applied to the electrodes, the membrane 120 will deform and move out of plane. The motion then pushes the acoustic coupling layer 114 it is in contact with and an acoustic (ultrasonic) wave is generated. Oftentimes, vacuum is present inside the cavity 130 and therefore damping contributed from the media within the cavity 130 can be ignored. However, the acoustic coupling layer 114 on the other side of the membrane 120 can substantially change the damping of the PMUT device 100. For example, a quality factor greater than 20 can be observed when the PMUT device 100 is operating in air with atmosphere pressure (e.g., acoustic coupling layer 114 is air) and can decrease lower than 2 if the PMUT device 100 is operating in water (e.g., acoustic coupling layer 114 is water).

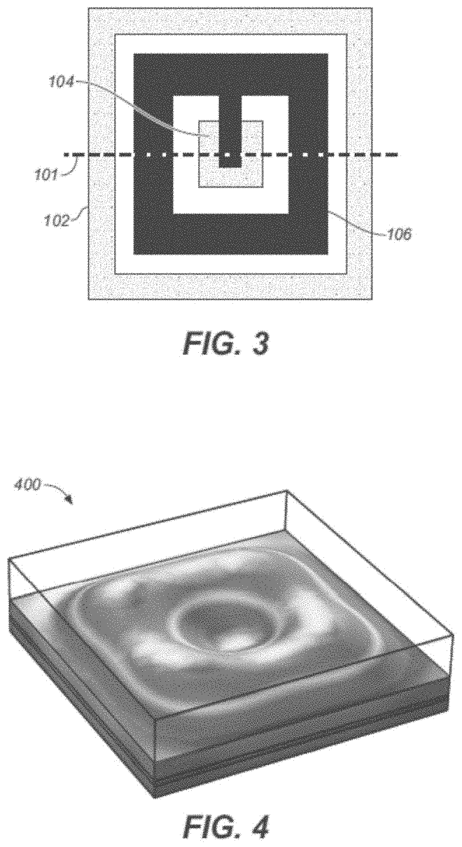

FIG. 3 is a top view of the PMUT device 100 of FIG. 1 having a substantially square shape, which corresponds in part to a cross section along dotted line 101 in FIG. 3. Layout of surrounding edge support 102, interior support 104, and lower electrode 106 are illustrated, with other continuous layers not shown. It should be appreciated that the term “substantially” in “substantially square shape” is intended to convey that a PMUT device 100 is generally square-shaped, with allowances for variations due to manufacturing processes and tolerances, and that slight deviation from a square shape (e.g., rounded corners, slightly wavering lines, deviations from perfectly orthogonal corners or intersections, etc.) may be present in a manufactured device. While a generally square arrangement PMUT device is shown, alternative embodiments including rectangular, hexagon, octagonal, circular, or elliptical are contemplated. In other embodiments, more complex electrode or PMUT device shapes can be used, including irregular and non-symmetric layouts such as chevrons or pentagons for edge support and electrodes.

FIG. 4 is a simulated topographic map 400 illustrating maximum vertical displacement of the membrane 120 of the PMUT device 100 shown in FIGS. 1-3. As indicated, maximum displacement generally occurs along a center axis of the lower electrode, with corner regions having the greatest displacement. As with the other figures, FIG. 4 is not drawn to scale with the vertical displacement exaggerated for illustrative purposes, and the maximum vertical displacement is a fraction of the horizontal surface area comprising the PMUT device 100. In an example PMUT device 100, maximum vertical displacement may be measured in nanometers, while surface area of an individual PMUT device 100 may be measured in square microns.

In one or more embodiments of the ultrasonic sensor, some or all of the transducers discussed herein and/or some or all of the functionalities (e.g., transmitting or receiving) of the transducers discussed herein can be replaced by a more bulk or film-based piezo electric material. The principles remain unchanged, using piezoelectric material in combination with one or more electrodes to generate ultrasonic waves.

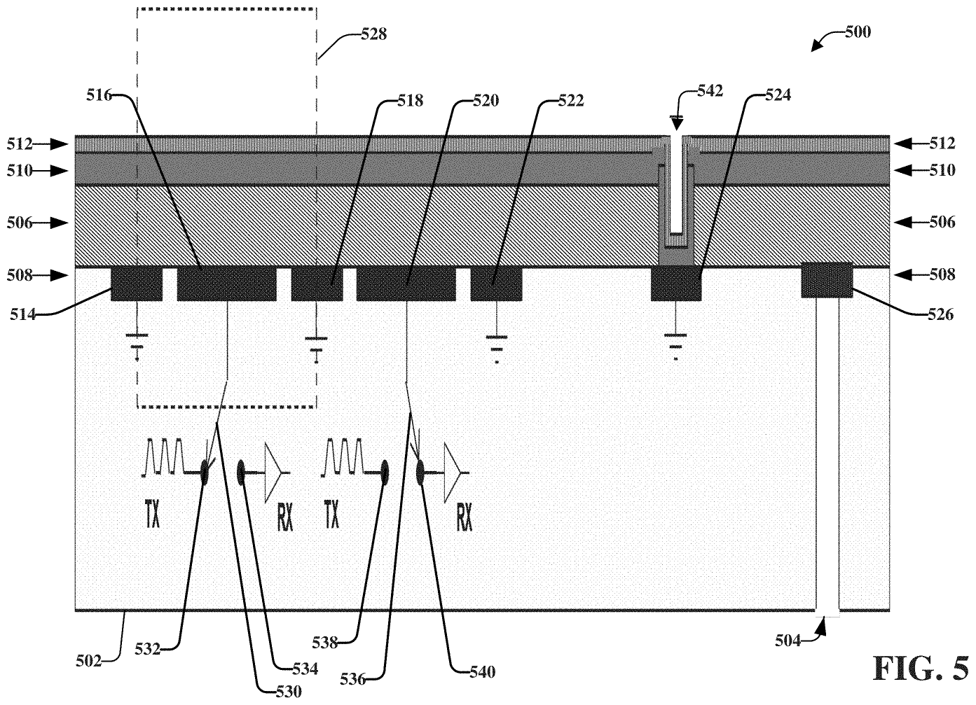

FIG. 5 illustrates an example, non-limiting, fingerprint sensor 500 that comprises a single electrode access in accordance with one or more embodiments described herein. As discussed above, in some embodiments, the upper electrode 108 can be formed as a continuous layer providing a ground plane. In the example of FIG. 5, the bottom electrode is patterned to control the different piezoelectric elements (transducers), and the top electrode is a continuous layer connected to ground, or any other desired potential. Therefore, this architecture can be referred to as a single electrode architecture since only a single electrode is controlled. The fingerprint sensor 500 can comprise a through-silicon via (TSV) package as illustrated by the architecture of FIG. 5, however the disclosed aspects are not limited to this implementation.

The fingerprint sensor 500 can comprise a substrate 502. In an example, the substrate can be a Complementary Metal-Oxide Semiconductor (CMOS). In this example, the substrate comprises a TSV 504. The fingerprint sensor 500 can also comprise a piezoelectric layer 506 located over the substrate 502 and in physical contact with two electrodes, namely a first electrode 508 and a second electrode 510. According to some implementations, the fingerprint sensor 500 can comprise more than two electrodes.

The first electrode 508 can be integrated with the substrate 502 or formed over the substrate 502. The piezoelectric layer 506 can be located over the substrate 502 and over (and in physical contact with) the first electrode 508. In accordance with some implementations, the piezoelectric layer 506 can be a continuous piezoelectric layer, for example, based on polymer based piezo electric material, such as, for example, PVDF, PVDF-TrFe, low temperature sol-gel PZT. The second electrode 510 can be located over and adjacent the piezoelectric layer 506 and over the first electrode 508. According to some implementations, the second electrode 510 can comprise aluminum. Further, the second electrode 510 can be operatively connected to the substrate 502 through a film. In addition, a passivation layer 512 can be located over the second electrode 510.

As illustrated, the first electrode 508 can be separated into a plurality of first electrode elements. For example, as illustrated the first electrode 508 can be separated into a first electrode element 514, a second electrode element 516, a third electrode element 518, a fourth electrode element 520, a fifth electrode element 522, a sixth electrode element 524, and a seventh electrode element 526. Although a certain number of electrode elements are shown and described, the disclosed aspects are not limited to this number and the first electrode 508 can be separated into fewer or more electrode elements than the number shown and described.

A single piezo element (e.g., a first piezo element 528) is depicted by the dashed box. The piezo element can also be referred to as a transducer (element), or pixel. Accordingly, for the first piezo element 528, the first electrode element 514 and the third electrode element 518 are connected to ground, which can electrically isolate (or insulate, mitigate crosstalk) the second electrode element 516. Further, the second electrode element 516 can be operatively connected to a switch 530. The switch 530 can be operable between a first position and a second position. For example, when in the first position, contacting a first node 532 (as illustrated), the switch 530 can place the first piezo element 528 into a transmit state (TX). Further, when in the second position, contacting a second node 534 (not illustrated), the switch 530 can place the first piezo element 528 into a receive state (RX). It is noted that the position of the switch can be reversed according to some implementations. For example, in the first position, the switch 530 can place the first piezo element 528 into a receive state and, in the second position, the switch 530 can place the first piezo element 528 into a transmit state.

Also illustrated is a second piezo element (not labeled), that comprises the fourth electrode element 520 surrounded (e.g., electrically isolated or insulated) by the third electrode element 518 and the fifth electrode element 522, which is also connected to ground, or any other desired potential.

The second piezo element can also comprise a switch 536 that can be operable between a first position and a second position. For example, when in the first position, contacting a third node 538, the switch 536 can place the second piezo element into a transmit state. Further, when in the second position, contacting a fourth node 540 (as illustrated), the switch 536 can place the second piezo element into a receive state. However, in an alternative implementation, when in the first position, the switch 530 can place the second piezo element into a receive state and, when in the second position, the switch 536 can place the second piezo element into a transmit state.

According to some implementations, the first electrode 508 can be referred to as a bottom electrode (or lower electrode) and the second electrode 510 can be referred to as a top electrode (or upper electrode).

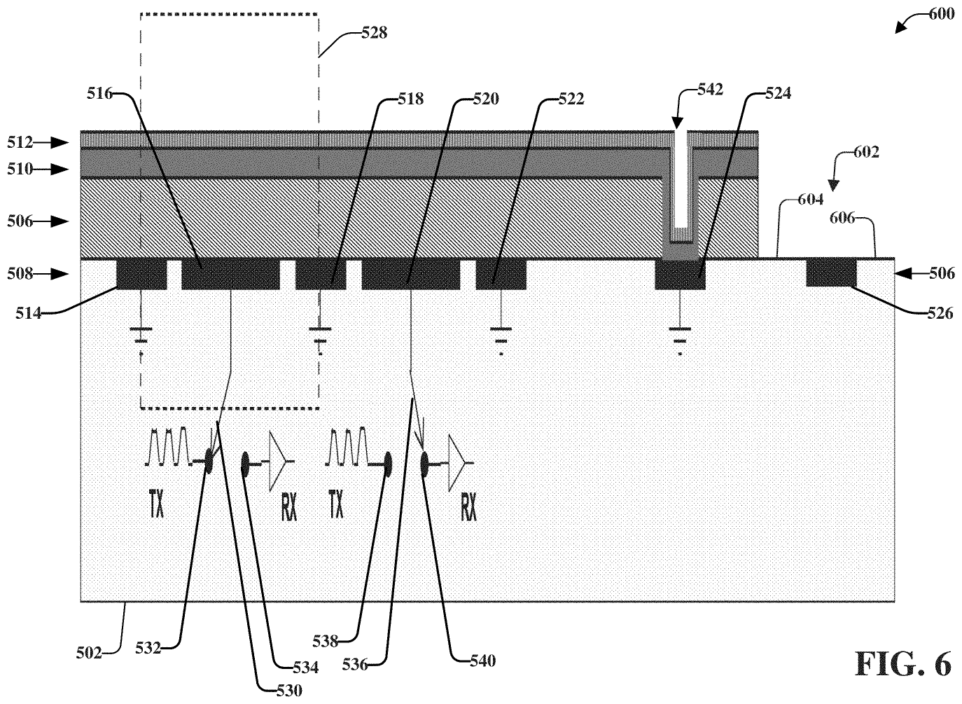

FIG. 6 illustrates another example, non-limiting, fingerprint sensor 600 that comprises a single electrode access in accordance with one or more embodiments described herein. Repetitive description of like elements employed in other embodiments described herein is omitted for sake of brevity.

The contact area 602 exposes CMOS bond pads. For example, the contact area 602 exposes the seventh electrode element 526 and areas 604 and 606 of the substrate 502. It is noted that the fingerprint sensor 500 of FIG. 5 has the TSV 504 that provides a contact area, while the fingerprint sensor 600 comprises the contact area 602.

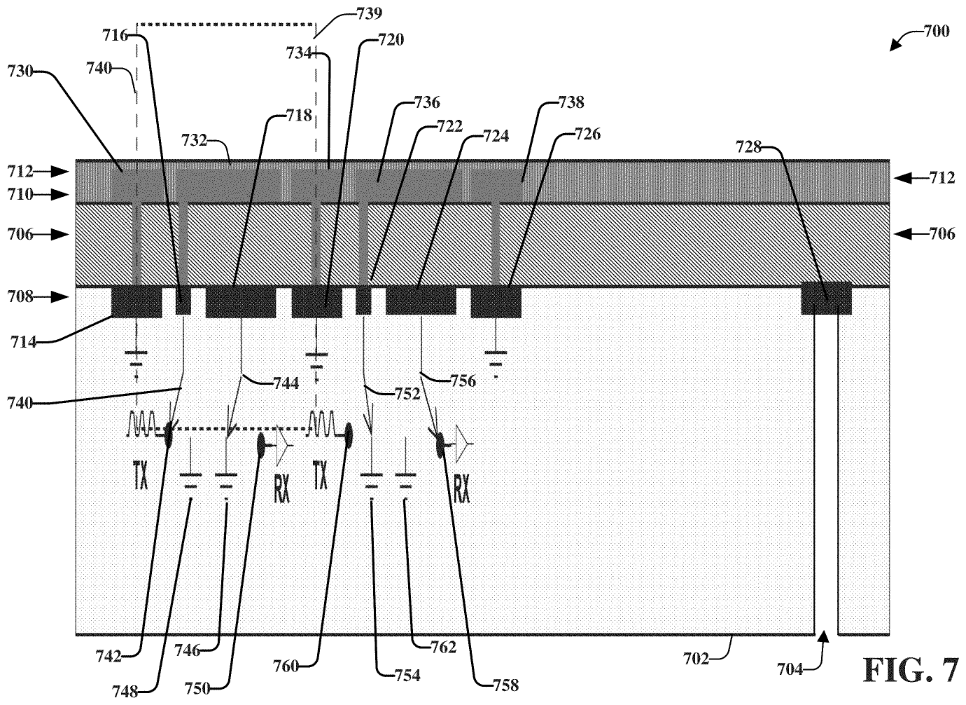

FIG. 7 illustrates an example, non-limiting, fingerprint sensor 700 that comprises a dual electrode access in accordance with one or more embodiments described herein. In this example, the bottom electrode and the top electrode are pattered to control the different piezoelectric elements (transducers). Therefore, this architecture can be referred to as a dual electrode architecture since both electrodes are controlled. The dual electrode architecture requires a more complicated manufacturing process compared to the single electrode architecture, however, the dual electrode architecture provides several advantages that can increase performance of the sensor. In the various embodiments provided herein, there can be more control of the electrodes and the electrodes can be driven in a differential mode.

The fingerprint sensor 700 can comprise a substrate 702. The substrate 702 can be a CMOS according to some implementations. In this example, the substrate comprises a TSV 704. Although the fingerprint sensor 700 is illustrated as a TSV package, the disclosed aspects are not limited to this implementation.

A piezoelectric layer 706 can be located over the substrate 702 and in physical contact with a plurality of electrodes. The plurality of electrodes can comprise a first electrode 708 and a second electrode 710. The first electrode 708 can also be referred to as a bottom electrode (or lower electrode) and the second electrode 710 can also be referred to as a top electrode (or upper electrode). According to some implementations, the fingerprint sensor 700 can comprise more than two electrodes. The first electrode 708 can be integrated with the substrate 702 or formed over the substrate 702. The second electrode 710 can be patterned and operatively connected to the substrate 502 through a film.

The first electrode 708 and the second electrode 710 can be located on opposite sides of the piezoelectric layer 706. For example, the first electrode 708 can be located at a first side (e.g., a bottom side as depicted in FIG. 7) of the piezoelectric layer 706 and the second electrode 710 can be located at a second side (e.g., a top side as depicted in FIG. 7) of the piezoelectric layer 706. The sensor can also comprise a passivation layer 712, which can be located over the second electrode 710.

The first electrode 708 can be separated into a plurality of first electrode elements. For example, as illustrated the first electrode 708 can be separated into a first electrode element 714, a second electrode element 716, a third electrode element 718, a fourth electrode element 720, a fifth electrode element 722, a sixth electrode element 724, a seventh electrode element 726; and an eighth electrode element 728. Although a certain number of electrode elements are shown and described, the disclosed aspects are not limited to this number and the first electrode 708 can be separated into fewer or more electrode elements than the number shown and described.

In addition, the second electrode 710 can be separated into a plurality of second electrode elements. For example, as illustrated, the second electrode 710 can be separated into (continuing the numbering for purposes of clarification) a ninth electrode element 730, a tenth electrode element 732, an eleventh electrode element 734, a twelfth electrode element 736, and a thirteenth electrode element 738.

A single piezo element (e.g., a first piezo element 739) is depicted by the dashed box. The first piezo element 739 is electrically isolated by a first electrode pair comprising the first electrode element 714 and the ninth electrode element 730 and a second electrode pair comprising the fourth electrode element 720 and the eleventh electrode element 734. The first electrode pair and the second electrode pair can be connected to ground, or any other desired potential.

Each piezo element can have a top electrode element (e.g., the tenth electrode element 732) and a bottom electrode element (e.g., the third electrode element 718) that can be used to transmit and receive ultrasonic waves using the piezo elements. The top element is connected to the substrate using a contact electrode (e.g., the second electrode element 716).

In the dual electrode architecture, the different top and bottom elements can be controlled separately during transmit mode and receive mode. For example, in transmit mode, one of the electrodes can be used as a drive electrode and the other electrode can be grounded, or at another desired potential. In receive mode, one of the electrodes can be used to receive the signal and the other electrode can be grounded, or at another desired potential. Electrode functionality can be inverted between transmit mode and receive mode. Switches in the substrate can be used to change functionality of the different electrodes during the various modes. For example, the first pair of electrode elements can be connected to a first switch (e.g., switching element), which can be operable between a first position and a second position. According to some implementations, the switch can be similar to a Double Pole Double Throw (DPDT) switch or another type of switch. For example, in a first position, a first terminal 740 of the first switch can be connected to a first node 742 and a second terminal 744 of the first switch can be connected to ground 746 (or another desired potential), which can place the first piezo element 739 in a transmit state. Further in a second position, the first terminal 740 of the switch can be connected to ground 748 (or another desired potential) and the second terminal 744 of the switch can be connected to a second node 750. With the switch in this position, it can place the first piezo element 739 in a receive state. It is noted that the various terminals, nodes, switches, and electrodes depicted serve merely as an example of the versatility of the dual electrode architecture, showing that the different electrodes of the piezo elements can be connected differently during the different modes.

Also illustrated is a second piezo element (not labeled), that can be electrically isolated by a second electrode pair comprising the fourth electrode element 720 and the eleventh electrode element 734 and a second electrode pair comprising the seventh electrode element 726 and the thirteenth electrode element 738. The first electrode pair and the second electrode pair are connected to ground.

The second piezo element can have a top electrode element (e.g., the twelfth electrode element 736) and a bottom electrode element (e.g., sixth electrode element 724) that can be used to transmit and receive ultrasonic waves using the piezo elements. The top electrode element is connected to the substrate using a contact electrode (e.g., the fifth electrode element 722).

For example, the second pair of electrode elements can be connected to a second switch (e.g., switching element), which can be operable between a first position and a second position. According to some implementations, the switch can similar to DPDT switch or another type of switch. For example, in a first position a first terminal 752 of the second switch can be connected to ground 754 (or another desired potential) and a second terminal 756 of the switch can be connected to a third node 758, which can place the second piezo element in a receive state. Further in a second position, the first terminal 752 of the second switch can be connected to a fourth node 760 and the second terminal 756 of the switch can be connected to ground 762 (or another desired potential). With the switch in this position, it can place the second piezo element in a transmit state. It is noted that the various terminals, nodes, switches, and electrodes depicted serve merely as an example of the versatility of the dual electrode architecture, showing that the different electrodes of the piezo elements can be connected differently during the different modes.

There can be a CMOS contact for the second electrode 710. Further, the second electrode 710 can be patterned according to some implementations. According to some implementations, the first electrode 708 can be referred to as a bottom electrode (or lower electrode) and the second electrode 710 can be referred to as a top electrode (or upper electrode).

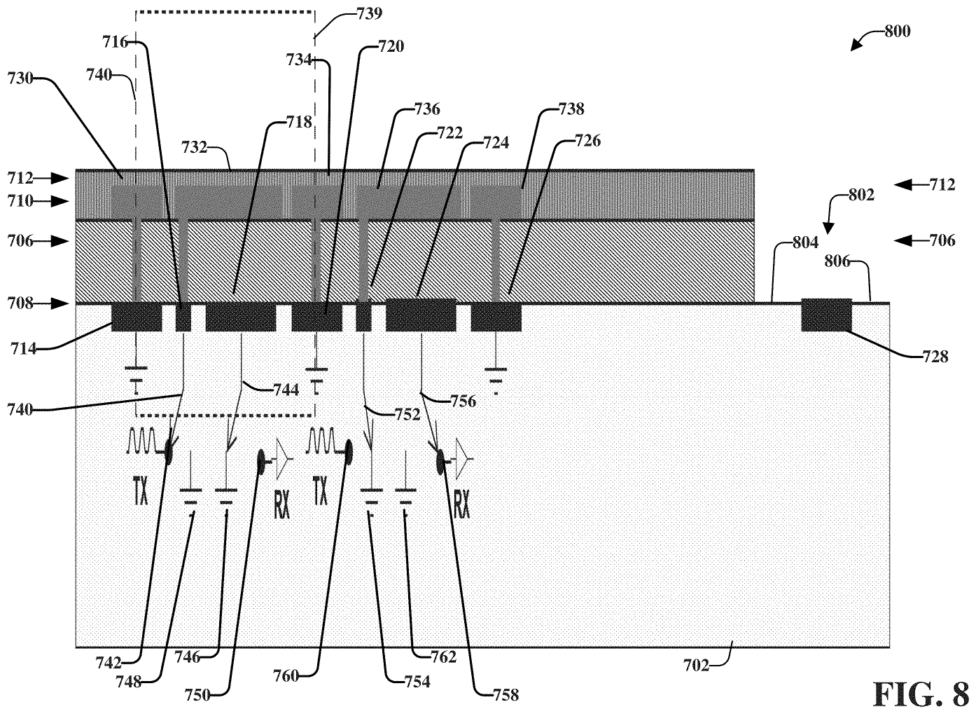

FIG. 8 illustrates another example, non-limiting, fingerprint sensor 800 that comprises a dual electrode access in accordance with one or more embodiments described herein. Repetitive description of like elements employed in other embodiments described herein is omitted for sake of brevity.

The second electrode can be patterned. Further, the contact area 802 exposes CMOS bond pads. For example, the contact area 802 exposes the eighth electrode element 728 and areas 804 and 806 of the substrate 702. It is noted that the fingerprint sensor 700 of FIG. 7 has the TSV 704 that provides a contact area, while the fingerprint sensor 800 comprises the contact area 802.

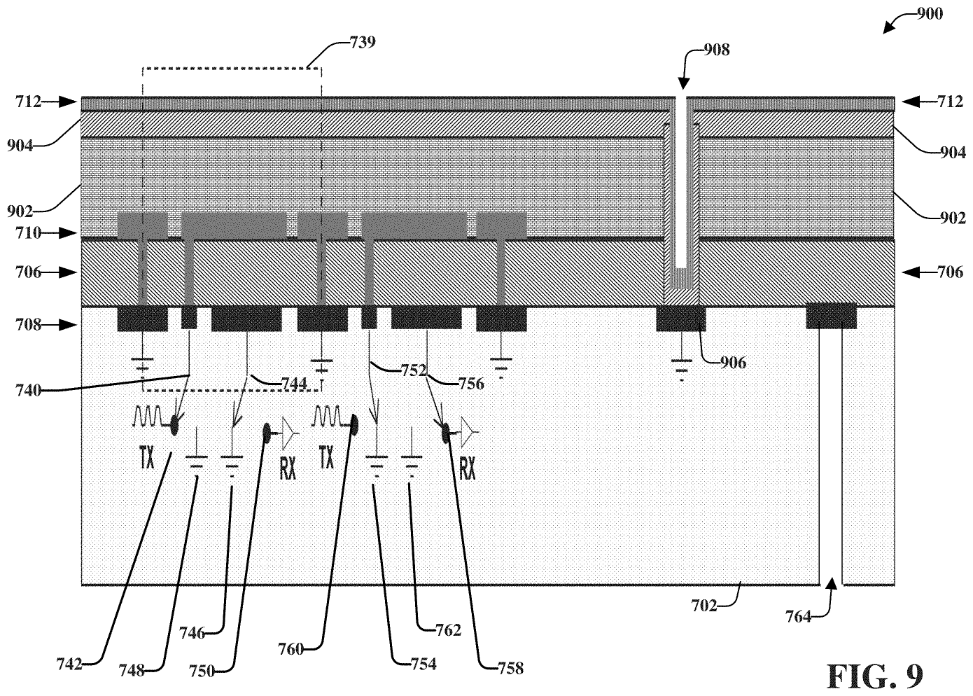

FIG. 9 illustrates an example, non-limiting, fingerprint sensor 900 with dual electrode access and Electromagnetic Interference (EMI) shield in accordance with one or more embodiments described herein. The EMI shield can be used to increase performance of the sensor by improving signal quality. Repetitive description of like elements employed in other embodiments described herein is omitted for sake of brevity.

The fingerprint sensor comprises an insulator 902 over the piezoelectric layer 706, and adjacent and over the second electrode 710. A third electrode 904 can be formed over and adjacent the insulator 902, adjacent the piezoelectric layer 706, and over another electrode element 906 of the first electrode 708. The passivation layer 712 can be formed over and adjacent the third electrode 904. It is noted that the passivation layer 712 above the EMI shield electrode can be optional if the platen is non-conductive or if the acoustic coupling layer is non-conductive.

There can be a CMOS contact 908 for the second electrode 710. Further, the second electrode 710 can be patterned according to some implementations. In addition, there can be a CMOS contact for the EMI shield.

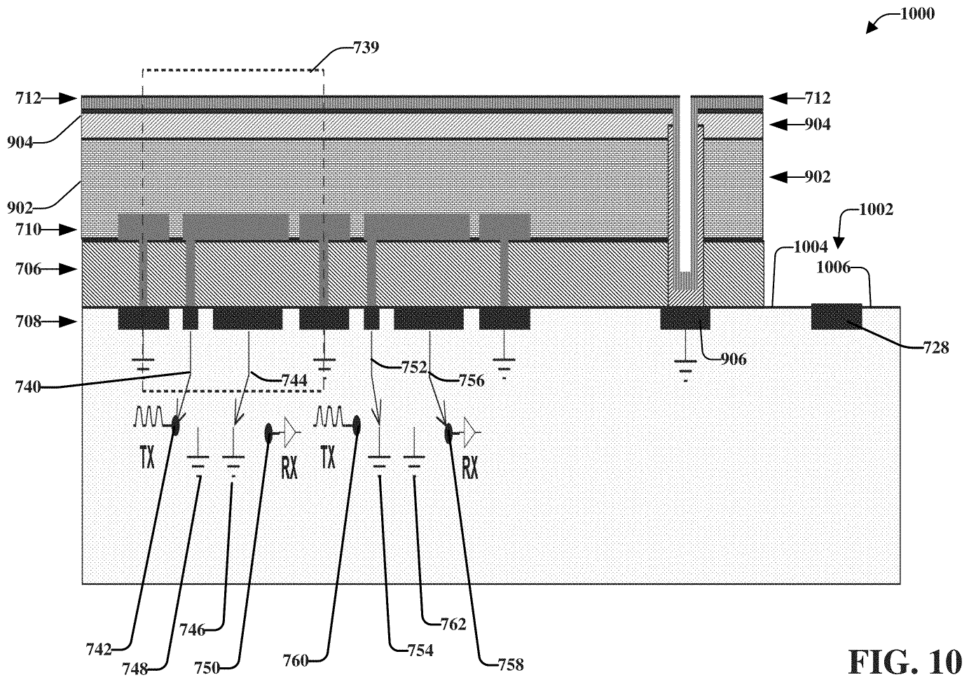

FIG. 10 illustrates another example, non-limiting, fingerprint sensor 1000 with dual electrode access and EMI shield in accordance with one or more embodiments described herein. Repetitive description of like elements employed in other embodiments described herein is omitted for sake of brevity.

The fingerprint sensor 1000 can comprise a contact area 1002. Further, the contact area 1002 exposes CMOS bond pads. For example, the contact area 1002 exposes the eighth electrode element 728 and areas 1004, 1006 of the substrate 702. It is noted that the fingerprint sensor 900 of FIG. 9 has the TSV that provides a contact area, while the fingerprint sensor 1000 comprises the contact area 1002. In addition, there can be a CMOS contact for the EMI shield.

As discussed herein, fingerprint sensors can use any type of piezoelectric material. The piezo electric material can be, for example, a bulk piezo electric material or a film based piezo electric material. The film based piezoelectric material can comprise a piezo-polymer such as, for example, PVDF/PVDF-TrFE, and the like. A piezo polymer can be coated directly on top of the CMOS. The CMOS top-metal can form one of the electrodes (e.g., the first electrode 508, the first electrode 708) for the piezo element. Another metal layer to be coated on top of the piezo polymer to form the second electrode (e.g., the second electrode 510, the second electrode 710).

The top electrode (e.g., the third electrode 904) can act as a common ground electrode shared between piezo elements. The grounded top electrode also acts as a shield for EMI interference. TX signal is applied to the bottom electrode (e.g., the first electrode 708). Also, RX signal is received on the bottom electrode (single electrode access architecture).

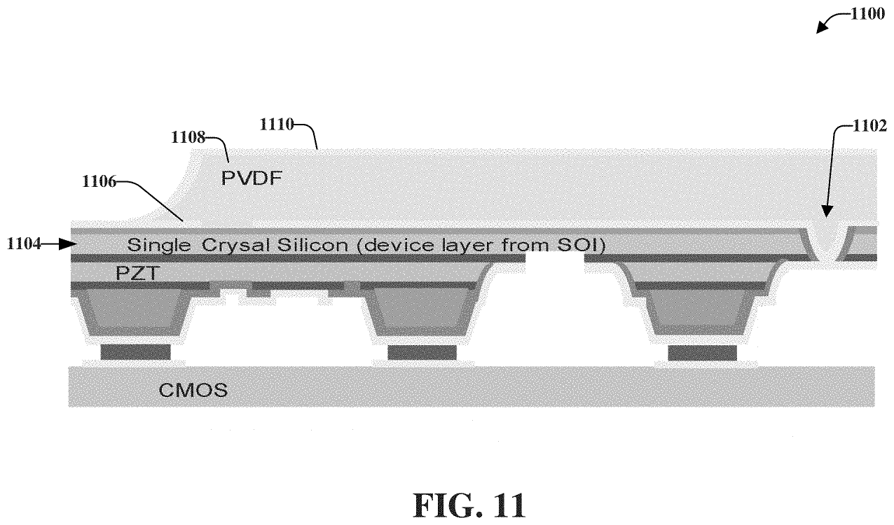

FIG. 11 illustrates an example, non-limiting, fingerprint sensor 1100 that comprises a PMUT plus bulk/film based piezoelectric film that is a combination of the one or more embodiments described herein. Repetitive description of like elements employed in other embodiments described herein is omitted for sake of brevity.

A bulk-mode piezo film (e.g. PVDF) can be coated on top of the PMUT. The structure can have four metal (electrode) layers, or some of the electrodes can be shared. The PMUT can be used for TX with the bulk-mode film for RX, or vice versa. For the differential drive, the electrodes used for TX can be driven with differential signal, providing around 6 dB higher TX pressure compared to a single-ended drive. For differential sense, the electrodes used for RX can be arranged such that the electrodes contact parts of the piezo film with out-of-phase stress. Taking as differential signal across these electrodes can help increase the RX signal.

Further, the TX and RX piezo material can be optimized. For example, separating the TX and RX functions between two piezoelectric layers allows for optimization of the material for both TX and RX. The same process of PZT/AlN PMUT with replacing MN with bulk-mode piezoelectric film (e.g. PVDF) can also be achieved.

As illustrated, a PMUT structure is fabricated. The PMUT structure can be a pinned PMUT structure with a center support structure according to some implementations. As illustrated, a via 1102 can be formed through a single crystal silicon layer 1104. A first metal layer 1106 is formed over the single crystal silicon layer 1104 and within the via 1102.

Further, a piezoelectric layer 1108 can be formed on top of the first metal layer 1106. According to some implementations, the piezoelectric layer 1108 can be a PVDF layer or another type. A second metal layer 1110 can be formed over the piezoelectric layer 1108. The first metal layer 1106 can be a first electrode (e.g., the first electrode 508, the first electrode 708). The second metal layer 1110 can be a second electrode (e.g., the second electrode 510, the second electrode 710).

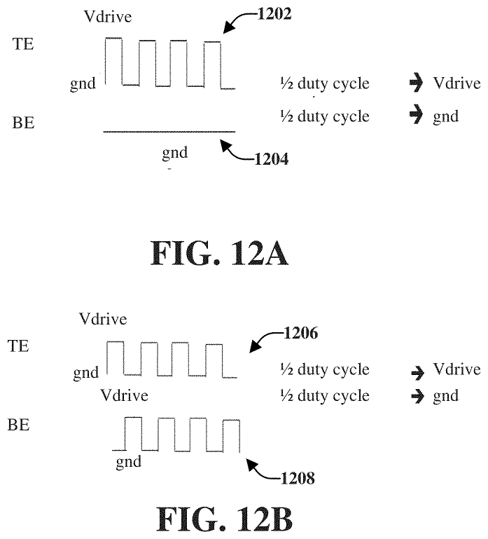

FIG. 12A illustrates an example, non-limiting, schematic representation of signals for a sensor that comprises a single drive.

Illustrated are a first signal 1202 for a top electrode (TE) and a second signal 1204 for a bottom electrode (BE). This architecture (single drive) uses the same electrode for TX and RX. In this example, the bottom electrode can be tied to electrical ground (although in some implementations, the top electrode can be tied to electrical ground). Accordingly, the first signal 1202 has a waveform that is between ground and Vdrive, during a drive signal. The second signal 1204 is tied to electrical ground, or any other desired potential. Accordingly, one electrode is used as a drive electrode and the other electrode is held at a constant potential. This created potential variation across the piezo element generates the ultrasound waves. Accordingly, there is a half duty cycle for Vdrive and a half duty cycle for ground (or other potential), although other percentages can also be used. The square waveform is used to explain the principles, but any type of waveform can be used (e.g. sine form). Because the same electrode is used for the transmission circuit and the receiving circuit, a coupling capacitor is needed between the transmission circuit and the receiving circuit. This results in signal loss due to the presence of the capacitive divider. By using separate electrodes for the transmission and receiving, this coupling capacitor is not needed, resulting in increased performance The presence of the ac-coupling cap help to prevent/block any of the TX signal from leaking into the receive chain. As a smaller TX voltage drive is used or a dual electrode system is used, this capacitor can be removed, which can help to improve the signal.

FIG. 12B illustrates an example, non-limiting, schematic representation of signals for a sensor that comprises a differential drive in accordance with one or more embodiments described herein. The differential drive mode is enabled due to the dual electrode architecture. In the dual drive mode, both electrodes are used as drive electrodes, meaning they both have a varying potential in order to generate the ultrasonic waves. Repetitive description of like elements employed in other embodiments described herein is omitted for sake of brevity.

Illustrated are a first signal 1206 for a top electrode or TE (e.g., the second electrode 510, the second electrode 710, the second metal layer 1110) and a second signal 1208 for a bottom electrode or BE (e.g., the first electrode 508, the second electrode 710, the first metal layer 1106).

With the differential drive as discussed herein, the first signal 1206 can have a similar waveform as the single drive. However, the second signal 1208 has a waveform that is inverse to the first signal 1206 (e.g., a phase shift, a 180 degree difference between a transmit state and a receive state). Other suitable phase shifts can also be applied depending, for example, on the transducer design. With the inverse polarity, the piezoelectric layer can be driven with more force as compared to the sensor of FIG. 12A. The half duty cycle in both cases is Vdrive and, therefore, twice the power can be output without inputting twice the amount of power. The voltage variation amplitude and used maximum and minimum voltage for the bottom and top electrodes can be identical, or they can be different. Accordingly, more signal can be achieved resulting in better sensor performance. The differential drive mode is used during the transmission phase, and the subsequent receive phase can use any of the variations discussed above. In addition to the differential drive mode, a differential receive mode can also be used due to the dual electrode architecture. For example, as the membrane flexes during receive, strain induced charges are generated across the piezo layer. Due to the different polarity of the charges induced as a function of the direction of the bending strains, the electrodes can be designed according to the shape and location of these strains to capture the differential signals.

The top electrode can also be patterned and separated between individual elements and vias can be etched to provide access from both electrodes to CMOS (dual electrode access architecture). This allows for separating the transmit (TX) and receive (RX) nodes. Due to this separation, the parasitic capacitance can be reduced, thus reducing the electrical power used for TX and reducing the signal loss during RX.

For the dual electrode access architecture, another layer of dielectric material (e.g. polyimide) can be coated along with a metal layer which can be grounded to provide the shield from EMI interference.

Further, provided is a PMUT with differential drive and sense. For the differential drive, two electrodes used for TX can be driven with differential signal, providing around 6 decibels (dB) higher TX pressure compared to a single-ended drive. For the differential sense, the electrodes used for RX can be arranged such that the electrodes contact parts of the piezo film with out-of-phase stress. Taking as differential signal across these electrodes can help increase the RX signal.

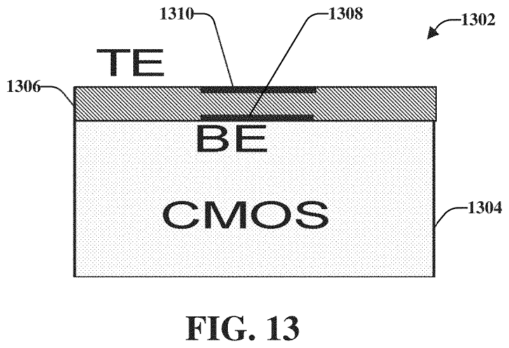

FIG. 13 illustrates a representation of a sensor 1302 that is formed on piezo in accordance with one or more embodiments described herein. Repetitive description of like elements employed in other embodiments described herein is omitted for sake of brevity.

As illustrated, the sensor 1302 can comprise a substrate 1304. Further, a piezoelectric layer 1306 can be formed between two electrodes, namely, a bottom electrode 1308 (BE) and a top electrode 1310 (TE). It is noted that the sensor 1302 of FIG. 13 is similar to the sensors of FIGS. 5-10.

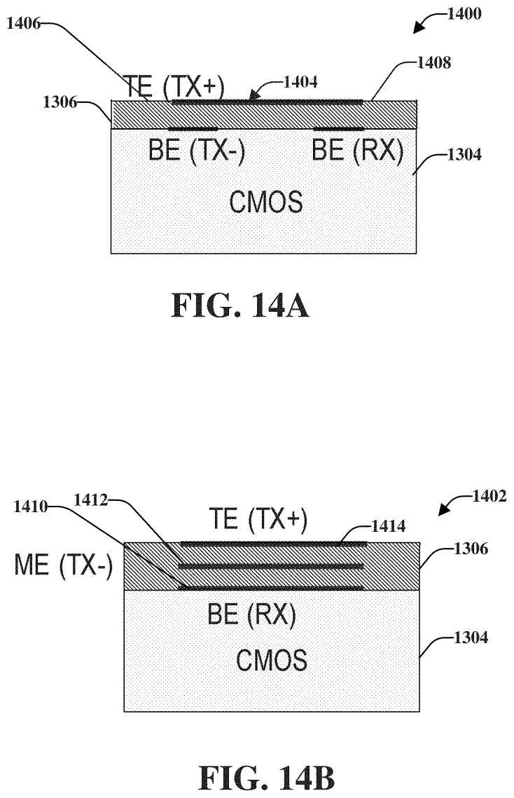

FIG. 14A illustrates an example, non-limiting, fingerprint sensor 1400 that comprises multiple electrodes with a single piezoelectric layer in accordance with one or more embodiments described herein. FIG. 14B illustrates an example, non-limiting, fingerprint sensor 1402 that comprises a multiple layer of piezo with multiple electrodes in accordance with one or more embodiments described herein. Repetitive description of like elements employed in other embodiments described herein is omitted for sake of brevity.

The fingerprint sensor 1400 of FIG. 14A can comprise a single top electrode 1404, which can be utilized for TX+). The fingerprint sensor 1400 also comprises a first bottom electrode 1406 for TX− and a second bottom electrode 1408 for RX.

The fingerprint sensor 1402 of FIG. 14B can comprise a bottom electrode 1410 for RX, a middle electrode (ME) 1412 for TX−, and a top electrode 1414 for TX+. It is noted that the alternative embodiments, although illustrated with respect to a sensor that is formed on piezo, the alternative embodiments can also be applied to a sensor that is formed on PMUT.

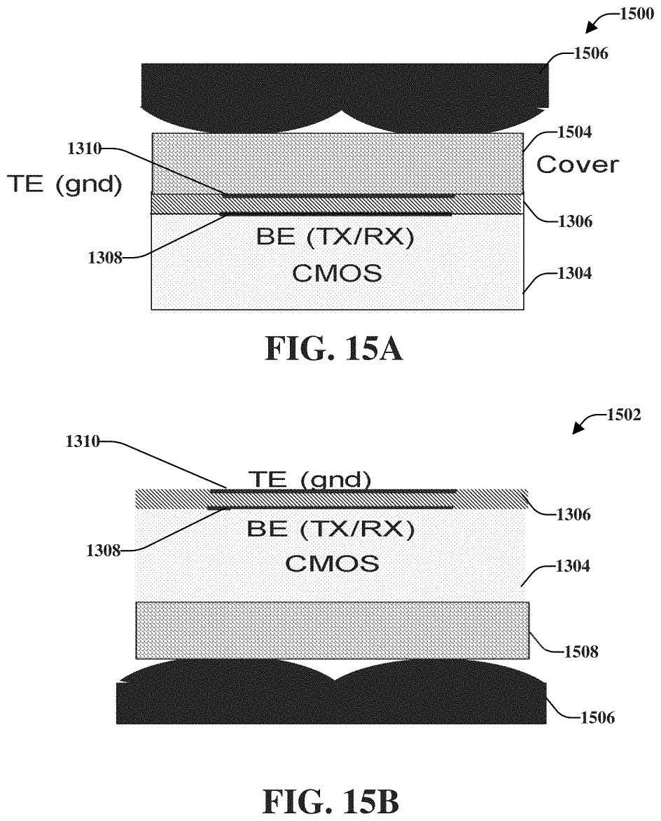

FIG. 15A illustrates a sensor 1500 that facilitates frontside sensing in accordance with one or more embodiments described herein. FIG. 15B illustrates a sensor 1502 that facilitates backside sensing in accordance with one or more embodiments described herein. Repetitive description of like elements employed in other embodiments described herein is omitted for sake of brevity.

As illustrated, for the sensor 1500 of FIG. 15A, a cover 1504 is over the top electrode 1314 and the piezoelectric layer 1306. Accordingly, a finger 1506 is detected through frontside sensing. Alternatively, for the sensor 1502 of FIG. 15B, a cover 1508 is below the substrate 1304. Thus, the finger 1506 can be detected with backside sensing where the acoustic wave propagates in the back and through the substrate 1304.

In some of the discussions above, the operation of the two-dimensional array of ultrasonic transducers was described using designs and architectures focused around Piezoelectric Micromachined Ultrasonic Transducer (PMUT) devices. However, the same principles of beamforming and beam steering discussed in relation to the PMUT architecture, can also be applied to other architectures of ultrasonic sensor. In some embodiments, these other architectures consist of two-dimensional arrays of ultrasonic transducers manufactured using alternative techniques. For example, architectures using piezoelectric bulk material, or piezoelectric films can be used. The piezoelectric bulk material or piezoelectric films can comprise similar materials as discussed in relation to the PMUT architecture, such as, but not limited to, Aluminum nitride (AlN), lead zirconate titanate (PZT), quartz, polyvinylidene fluoride (PVDF), and/or zinc oxide, to facilitate both acoustic signal production and sensing.

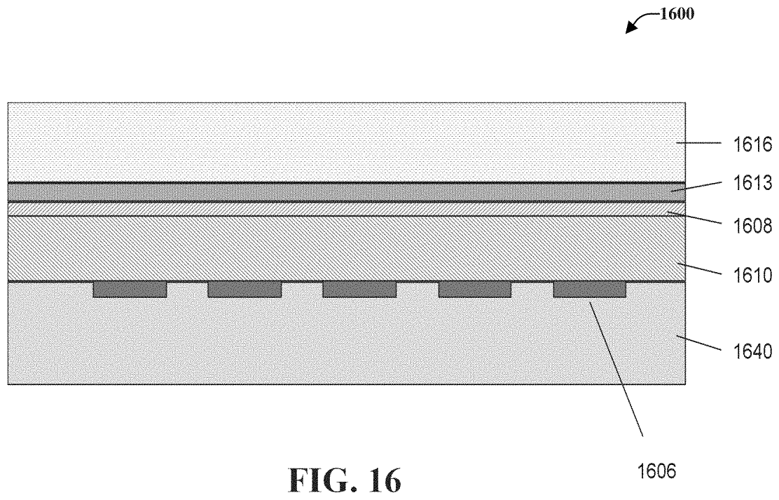

FIG. 16 illustrates a device 1600 that comprises an architecture using piezoelectric bulk material or a piezoelectric film to generate and/or detect the ultrasonic waves in accordance with one or more embodiments described herein. Device 1600 can comprise a piezoelectric layer 1610 positioned over a substrate 1640. The piezoelectric layer 1610 can comprise of a single layer or can comprise multiple layers. In an embodiment, the piezoelectric layer 1610 can be used to transmit the ultrasonic signal and receive the reflected ultrasonic signals. In another embodiment, the piezoelectric layer 1610 can be used to only transmit the ultrasonic signals. In this case, another layer or structure within device 1600 can be used to receive the ultrasonic signals. In yet another embodiment, the piezoelectric layer 1610 can be used to only receive the ultrasonic signals, other layers or structure within device 1600 can be used the transmit the ultrasonic signals.

The electrodes (e.g., a lower electrode 1606 and an upper electrode 1608) can be used to apply the electric charge to the piezoelectric layer for transmitting the ultrasonic signal or can be used to detect the received ultrasonic signal. As illustrated, the lower electrode 1606 can be coupled to a lower surface of the piezoelectric layer 1610 and the upper electrode 1608 can be coupled to an upper surface of the piezoelectric layer 1610. The lower electrode 1606 can be deposited on substrate 1640 or can be integrated into substrate 1640. In the embodiment of FIG. 16, the lower electrode 1606 can be structured as a two-dimensional array or electrodes in order to control individual ultrasonic transducers. The upper electrode 1608 can cover several ultrasonic transducers and can be grounded. In other embodiments, both the lower electrode 1606 and the upper electrode 1608 can be structured as a-two-dimensional array of electrodes.

The device 1600 can optionally comprise an adhesive layer 1613 to attach platen 1616 to the remainder of the stack. In addition, optionally, the device 1600 can comprise an acoustic coupling layer between any of the layers of the device (not shown).

In an embodiment, the piezoelectric layer 1610 is a continuous film positioned above the substrate 1640. In other embodiments, the piezoelectric layer 1610 is structured, for example into a two-dimensional array of piezoelectric elements. Each piezoelectric element can cover one or more electrodes of the two-dimensional array of electrodes. The piezoelectric layer 1610 can have a thickness of only a few micrometers (e.g. 1-10 m) or can be a thicker layer up to around 50 um, or more. The exact thickness can be selected depending on the desired ultrasonic properties and settings, such as for example, the frequency of the ultrasonic signals. The frequency of the ultrasonic signals can vary from a few MHz (e.g. 5-10 MHz) to several tens of MHz (e.g. 50 MHz). The frequency can be selected based on the required ultrasonic properties or settings. Higher frequencies (e.g. 30-50 MHz) are usually better suited for beam forming compared to lower frequencies (e.g. 5-1-MHz). The piezoelectric layer 1610 can comprise (organic) ferroelectric polymers such as, for example, polyvinylidene fluoride (PVDF) or a copolymer of poly vinylidene fluoride and trifluoroethylene (PVDF-TrFE). Molar percentage of the PVDF in the PVDF-TrFE copolymer can vary, for example, for 50 to 90 percent. Manufacture and optimization of the ferroelectric polymers for the piezoelectric layer 1610 will not further be discussed herein for purposes of simplicity.

Operation of the device 1600 can be performed in a similar manner as discussed above in relation to the PMUT architecture. The main principles of beamforming and/or beam steering apply in a similar manner, irrespective of architecture type. Some parameters or control setting can be adjusted to account for the difference in architecture.

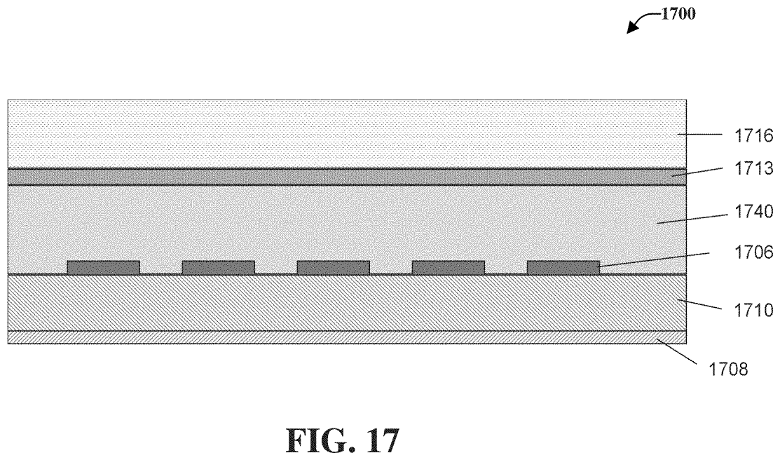

FIG. 17 illustrates a device 1700 that comprises an architecture using piezoelectric bulk material or a piezoelectric film to generate and/or detect the ultrasonic waves in accordance with one or more embodiments described herein. Repetitive description of like elements employed in other embodiments described herein is omitted for sake of brevity.

The device 1700 is similar to device 1600, except for the platen 1716, which is positioned on the opposite side of the substrate 1640 with respect to the piezoelectric layer 1710. In other words, the piezoelectric layer 1710 is positioned on a first side of the substrate 1740 together with the lower electrode 1706 and the upper electrode 1708, and the platen 1716 is mounted a second side of the substrate 1740, using optional adhesive layer 1713. As a result of this alternative/inversed architecture, the ultrasonic signals traverse the substrate 1740 to and from the platen 1716. Operation of the device 1700 can be adapted compared to operation of the device 1600 to account for this difference. The substrate 1740 can also be modified to limit diffraction and other effects that can interfere with the ultrasonic signals. For example, if the substrate 1740 is made of a high diffractive material, this can interfere with beamforming and therefore make beamforming less effective. The device 1700 can further contain additional layers below the upper electrode 1708 for (electric) protection or insulation purposes (not shown).

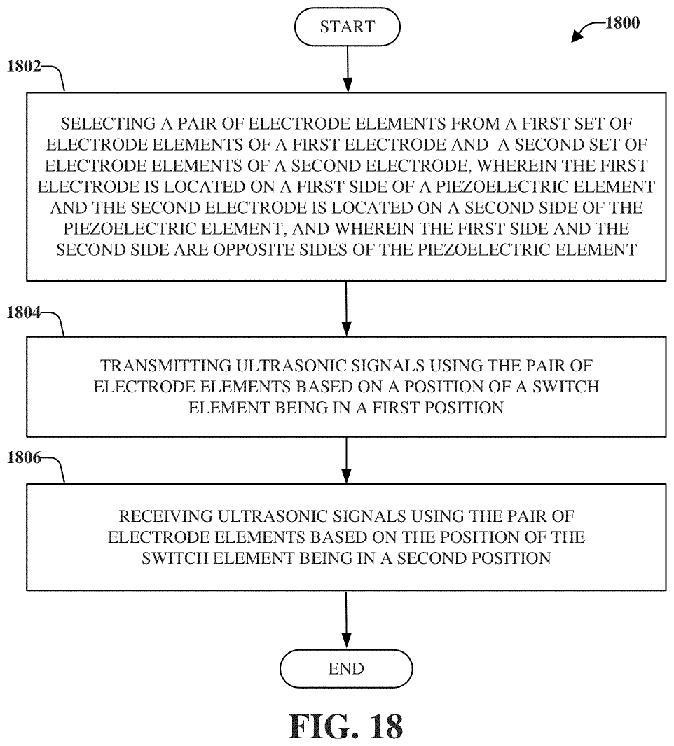

FIG. 18 illustrates a flow diagram of an example, non-limiting, method 1800 for operating a sensor device in accordance with one or more embodiments described herein. At 1802, a pair of electrode elements can be selected from a first set of electrode elements of a first electrode and a second set of electrode elements of a second electrode. The first electrode can be located on a first side of a piezoelectric element and the second electrode can be located on a second side of the piezoelectric element. The first side and the second side can be opposite sides of the piezoelectric element.

Ultrasonic signals can be transmitted, at 1804, using the pair of electrode elements based on a position of a switch element being in a first position. Transmitting the ultrasonic signals can comprise applying a differential drive to the pair of electrode elements.

Further, at 1806, ultrasonic signals can be received using the pair of electrode elements based on the position of the switch element being in a second position. Receiving the ultrasonic signals can comprise applying a differential sense to the pair of electrode elements. Further, the second set of electrode elements can be arranged to contact portions of the piezoelectric element with an out-of-phase stress based on receiving the ultrasonic signals.

In an example, a phase shift can be applied between a transmit signal used for the transmitting the ultrasonic signals and a receive signal used for the receiving the ultrasonic signals. The phase shift can be a 180 degree difference between the transmit state and the receive state.

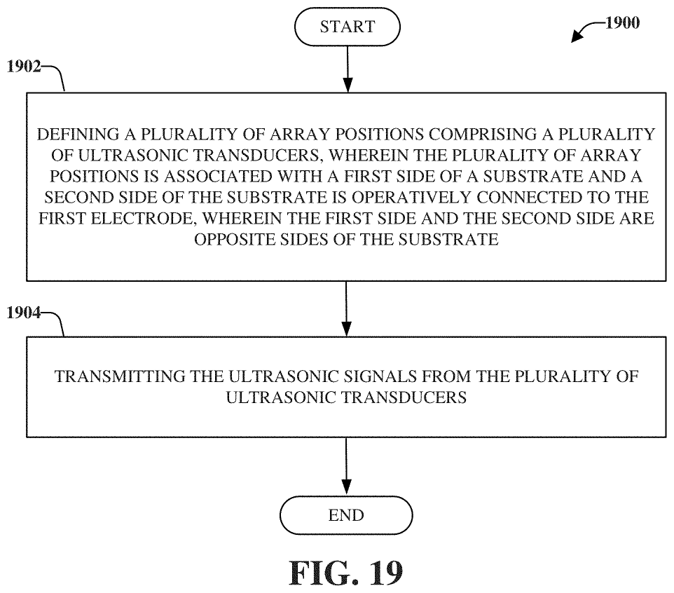

FIG. 19 illustrates a flow diagram of an example, non-limiting, method 1900 for operating a sensor device for backside sensing in accordance with one or more embodiments described herein. Repetitive description of like elements employed in other embodiments described herein is omitted for sake of brevity.

At 1902, a plurality of array positions comprising a plurality of ultrasonic transducers can be defined. The plurality of array positions can be associated with a first side of a substrate and a second side of the substrate can operatively connected to a first electrode. The first side and the second side can be opposite sides of the substrate. Further, at 1904, the ultrasonic signals can be transmitted from the plurality of ultrasonic transducers.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification procedures and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can comprise, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A sensor comprising:
a substrate;
a piezoelectric layer located over the substrate and in physical contact with a plurality of electrodes,
wherein the plurality of electrodes comprise a first electrode and at least a second electrode, wherein the first electrode is integrated with the substrate and the second electrode is patterned and operatively connected to the substrate through a film, wherein the first electrode and the second electrode are located on opposite sides of the piezoelectric layer,
wherein the first electrode is separated into a plurality of first electrode elements and the second electrode is separated into a plurality of second electrode elements, and
wherein at least one pair of electrode elements, selected from the plurality of first electrode elements and the plurality of second electrode elements, are used for transmitting or receiving ultrasonic signals.

2. The sensor of claim 1, wherein the at least one pair of electrode elements is used in a differential mode.

3. The sensor of claim 2, wherein the differential mode is a differential drive.

4. The sensor of claim 2, wherein the differential mode is a differential sense.

5. The sensor of claim 2, wherein a phase shift is applied to a signal between a transmit state and a receive state.

6. The sensor of claim 5, wherein the phase shift is a 180-degree difference between the transmit state and the receive state.

7. The sensor of claim 1, further comprising a third electrode separated from the second electrode by an insulator.

8. The sensor of claim 1, further comprising a switching element that comprises a first position and a second position, wherein in the first position the switching elements facilitates the transmitting, and in the second position the switching element facilitates the receiving.

9. The sensor of claim 8, wherein in the first position, the switching element operatively connects at least a first electrode element of the plurality of first electrode elements and at least a first electrode element of the plurality of second electrode elements, and wherein in the second position, the switching element operatively connects at least a second electrode element of the plurality of first electrode elements and at least a second electrode element of the plurality of second electrode elements.

10. The sensor of claim 1, wherein the piezoelectric layer comprises a polyvinylidene fluoride (PVDF) layer.

11. The sensor of claim 1, wherein the piezoelectric layer is one of a film layer, a bulk layer, or separate elements.

12. The sensor of claim 1, further comprising a cavity between the piezoelectric layer and the substrate.

13. The sensor of claim 1, wherein the sensor is a Piezoelectric Micromachined Ultrasonic Transducer (PMUT).

14. A method, comprising:
selecting a pair of electrode elements from a first set of electrode elements of a first electrode and a second set of electrode elements of a second electrode, wherein the first electrode is located on a first side of a piezoelectric layer and the second electrode is located on a second side of the piezoelectric layer, and wherein the first side and the second side are opposite sides of the piezoelectric layer;
transmitting ultrasonic signals using the pair of electrode elements based on a position of a switch element being in a first position; and
receiving ultrasonic signals using the pair of electrode elements based on the position of the switch element being in a second position.

15. The method of claim 14, wherein the transmitting the ultrasonic signals comprises applying a differential drive to the pair of electrode elements.

16. The method of claim 14, wherein the receiving the ultrasonic signals comprises applying a differential sense to the pair of electrode elements, wherein the second set of electrode elements are arranged to contact portions of the piezoelectric layer with an out-of-phase stress based on the receiving the ultrasonic signals.

17. The method of claim 14, further comprising:
facilitating backside sensing of a sensor, comprising:
defining a plurality of array positions comprising a plurality of ultrasonic transducers, wherein the plurality of array positions is associated with a first side of a substrate and a second side of the substrate is operatively connected to the first electrode, wherein the first side and the second side are opposite sides of the substrate; and
transmitting the ultrasonic signals from the plurality of ultrasonic transducers.

18. The method of claim 17, wherein the sensor is a Piezoelectric Micromachined Ultrasonic Transducer (PMUT).

19. The method of claim 14, further comprising:
applying a phase shift between a transmit signal used for the transmitting the ultrasonic signals and a receive signal used for the receiving the ultrasonic signals.

20. The method of claim 18, wherein the phase shift is a 180 degree difference between the transmit state and the receive state.
